(19) United States
(12) Patent Application Publication
(10) Pub. No.: US 2021/0331134 A1
(43) Pub. Date: Oct. 28, 2021

(54) Micro-Pulse Micro-Arc Processing in Rotating Electromagnetic Fields

(71) Applicants: Joseph Brifman, Palm Coast, FL (US); Oleksandr Harni, Kyiv (GB)

(72) Inventors: Joseph Brifman, Palm Coast, FL (US); Oleksandr Harni, Kyiv (GB)

(21) Appl. No.: 17/238,759

(22) Filed: Apr. 23, 2021

Related U.S. Application Data
(60) Provisional application No. 63/015,997, filed on Apr. 27, 2020.

(51) Int. Cl. B01J 19/08; B01J 19/24

(52) U.S. Cl. CPC B01J 19/087; B01J 2219/0854; B01J 2219/0871; B01J 19/2415

(57) ABSTRACT

A system for processing air, water, and solid waste material and method of use. The system for processing waste material comprises a tubular reactor through which waste material is passed. The tubular reactor comprises an inductor configured to produce a rotating magnetic field. A plurality of needle-shaped ferromagnetic elements are disposed within a cylindrical working zone of the reactor. The needle-shaped ferromagnetic elements oscillate reaching several thousand periods per second. The system and method for processing natural, synthetic and waste material utilizes micro-pulse micro-arc processing of the material in the rotating magnetic fields to convert organic and inorganic waste into purified raw materials that are usable with minimal reprocessing.

### CROSS-REFERENCE TO RELATED APPLICATION

The present application claims priority to, and the benefit of, U.S. Provisional Application No. 63/015,997, which was filed on Apr. 27, 2020 and is incorporated herein by reference in its entirety.

### FIELD OF THE INVENTION

The present invention generally relates to a system and method for processing air, water, and solid waste, and more specifically to a system and method for reprocessing most types of waste as well natural, synthetic and raw materials into major sources of key materials using a reactor that uses multiple short spark source discharges that are influenced by a rotating electromagnetic field. Accordingly, the present specification makes specific reference thereto. However, it is to be appreciated that aspects of the present invention are also equally amenable to other like applications, devices, and methods of manufacture.

### BACKGROUND OF THE INVENTION

By way of background, an ideal economy should self-sustaining and resilient. An ability to adjust to changes in population, economic growth, natural hazards and variability in production and demand requires a level of sophistication at all stages of production, processing, and waste management. A major limitation is the use and re-use of water and the optimization of all systems using best available technologies to approach the concept of zero waste.

Many technologies that are presented for dealing with environmental contaminants are either specific to the target, incremental improvements to existing technology, or need supplementary technology to deal with by-products created in the process or wasteful concentrates. The aim of a zero-waste system with zero discharges, accompanied by a lowered energy requirement, smaller footprint, and flexible design, as well as a fast start-up and shut-down to and from full operation, has been met in only a very few instances and even then only for a limited number of applications. Accordingly, industry and regulators are stuck with traditional technologies that have well known limitations. Small, incremental improvements over time or novel treatment technologies have added to the process trains but the goal of zero-discharges is missing.

In chemical treatment processes, impurities are removed as particles from the water as precipitates or colloids. These are accumulated in settling tanks prior to discharge in permitted areas or for delivery to shore based waste units. In some cases, they are adsorbed or accumulated onto other materials or targets such as in filtration or electrochemical systems. The shortcomings of existing systems using physical and chemical principles of purification include high construction and operating costs; the need for cleaning of units; complexity of the control and monitoring systems, large bulk and mass, and the need for specialized ventilation and additional safety measures for confined spaces. These are often combined with membrane or other types of filtration systems to remove residual solids or microorganisms. A further disadvantage of chemical treatment systems is that the treatment products prepared by these methods can contain residues of chemically active substances that are harmful to the aquatic and marine biosphere so that further treatments are required.

The biological treatment of wastewater uses bacteria that process impurities into a substance that can be removed by microbial conversion to energy or adsorbable species or gases amongst other forms. Biological treatment systems require creation and maintenance of optimal conditions for the existence and multiplication of bacteria, with considerable time required to put the plant into operation after prolonged interruptions to operation. While marine based biological systems with brackish or saltwater are now relatively common, they are sensitive to changes in feed water composition. Biochemical treatment units need to be continuously fed to avoid incomplete treatment or prolonged start up times. When the delivery of wastewater to the unit is reduced or stopped, the sludge biomass activity reduces with corresponding reductions in treatment efficacy sometimes for extended periods.

Widely used technologies and equipment for disposal of wastewater use multistage cleaning methods: reagent treatment, coagulation, aeration, sedimentation, filtration, neutralization of slimes, clarification and more. An important factor that degrades the technical and economic efficiency is the low process intensity in the operating zones due to relatively low concentrations of the active components. Processes are correspondingly slow so that the size of the equipment is large, with low material and energy efficiency.

A wastewater stream typically contains mixtures of various substances which are physically combined but may, or may not, be chemically combined in solid and liquid phases. These mixtures may differ in chemical and physical properties from the individual substances from which they originated. These solid-phase waste stream components may be settleable solids, suspended solids, or colloidal solids. The liquid-phase components may be colloids, soluble compounds, gases, or ions. Colloids are solids of such small size that they are dispersed with an adsorbed charge to maintain stasis in the liquid phase. These colloids are mixtures in which the particles are invisible to the naked eye, cannot be removed by filtration, but can be contained within a semi-permeable membrane. Solids may be encountered in liquids under several forms: slurries, solutions, colloidal dispersions, and solid suspensions.

Accordingly, there is a great need for a technology that enables the conversion of organic and inorganic sludges, mine tailing accumulations, sewage from all sources, industrial waste, and construction waste, into raw materials for reuse with minimal processing. There is also a need for a zero discharge processing of domestic and industrial wastes with on-site or local re-use. Similarly, there is a need for a chemical treatment process that is not harmful to the aquatic and marine biosphere. There is also a need for a way to remove environmental contaminates that is flexible, requires low energy, and has a small footprint.

In this manner, the improved system of the present invention accomplishes all of the forgoing objectives, thereby providing an easy solution for converting sludges, mine tailing accumulations, sewage from all sources, industrial waste including organic and non-organic hazardous waste, and construction waste, into raw materials for reuse with minimal processing. A primary feature of the present invention is a way to convert organic waste into a high quality organic fertilizer by removing chemical impurities. The present invention allows for non-organic waste to be converted into metal oxides or stable chemical components for use as construction materials. The present invention can generate new materials and provide new synthesis pathways such as conversion of nitrogen and carbon to urea. Finally, the improved system of the present invention is capable of reprocessing most types of waste into major sources of key materials while minimizing wastes from many existing industries, thereby preventing new accumulations while conserving and recycling water resources. Importantly, the system requires no major oxygen inputs as with biological processes and no biological inputs.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a system for processing waste material. The system generates micro arcs and power micro impulses to treat the waste material. The system comprises a tubular reactor and a plurality of ferromagnetic elements. The tubular reactor comprises a tubular chamber and an inductor. The tubular chamber comprises a shell and a cylindrical working area. The cylindrical zone is encapsulated by the shell. The shell is magnetically nonreactive with the inductor. The tubular chamber may further comprise a jacket. The jacket is an insulated sleeve that lines the shell.

The inductor comprises a magnetic circuit and a winding. The winding is configured to generate a rotating electromagnetic field within the tubular chamber uniformly distributed and perpendicular to its axis. The winding may be a symmetrical reduced two-layer loop. The tubular reactor further comprises a power regulator. The power regulator is in electrical communication with the inductor. The tubular reactor further comprises a reactor cooling component. The reactor cooling component is configured to cool the inductor with water or oil. The tubular reactor is further configured to regulate the frequency of the supplied power.

The plurality of ferromagnetic elements are positional within the cylindrical working area of the tubular chamber. The plurality of ferromagnetic elements are needle-shaped and configured to kinetically interact with the waste material when triggered by the rotating magnetic field generated by the inductor. The activated plurality of ferromagnetic elements generate the micro arcs and power micro impulses that kinetically treats the waste material. Depending on the waste material to be treated, the plurality of ferromagnetic elements may be coated with a catalytic metal or an elastic polymer shell.

The subject matter disclosed and claimed herein, in one embodiment thereof, comprises a method for processing waste material using a system for processing waste material. The system generates micro arcs and power micro impulses to treat the waste material. The method begins by pretreating the waste material using a traditional waste material treatment process. Pretreating is necessary to reduce the size of the waste materials to approximately 2 mm or less so that complete processing may be accomplished with the system. Normal screening or pretreatment processes are typically employed to achieve this. Then the pretreated waste material is treated with the system for processing waste material.

The system comprises a tubular reactor and a plurality of ferromagnetic elements. The tubular reactor comprises a tubular chamber and an inductor. The tubular chamber comprises a shell and a cylindrical working area. The cylindrical working area is encapsulated by the shell. The shell is magnetically nonreactive with the inductor. The tubular working chamber may further comprise a jacket. The jacket is an insulated sleeve that lines the shell.

The inductor comprises a magnetic circuit and a winding. The winding is configured to generate a rotating electromagnetic field within the tubular chamber uniformly distributed and perpendicular to its axis. The winding may be a symmetrical reduced two-layer loop. The tubular reactor further comprises a power regulator. The power regulator is in electrical communication with the inductor. The tubular reactor further comprises a reactor cooling component. The reactor cooling component is configured to cool the inductor with water or oil. The tubular reactor is further configured to regulate the frequency of the supplied power.

The plurality of ferromagnetic elements are positional within the cylindrical working area of the tubular working chamber. The plurality of ferromagnetic elements are needle-shaped and configured to kinetically interact with the waste material when activated by the rotating magnetic field generated by the inductor. The activated plurality of ferromagnetic elements generate the micro arcs and power micro impulses that kinetically treats the waste material. Depending on the waste material to be treated, the plurality of ferromagnetic elements may be coated with a catalytic metal or an elastic polymer shell.

The method continues by separating the treated waste material into usable component materials. The method may further comprises retreating at least a portion of the treated waste material with the system for treating waste material. Once retreated, the retreated waste material is separated into usable component materials.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of a system for processing waste material of the present invention in accordance with the disclosed architecture.

FIG. 2 illustrates a rear perspective view of the system for processing waste material of the present invention in accordance with the disclosed architecture.

FIG. 3 illustrates an image of an operating zone of the system for processing waste material of the present invention in accordance with the disclosed architecture.

FIG. 4 illustrates a side cutaway view of a tubular reactor of the system for processing waste material of the present invention in accordance with the disclosed architecture.

FIG. 5 illustrates an end cutaway view of the tubular reactor of the system for processing waste material of the present invention in accordance with the disclosed architecture.

FIG. 6 illustrates a schematic view of a three-phase two-pole loop double-layer with a short pitch stator winding scheme of the tubular reactor of the system for processing waste material of the present invention in accordance with the disclosed architecture.

FIG. 7 illustrates a chart illustrating a differential between results of using a rotating magnetic field of the system for processing waste material versus using a traditional mixer to process waste.

FIG. 8 illustrates a schematic view of a method of processing waste material of the present invention using the system for processing waste material in accordance with the disclosed architecture.

FIG. 9 illustrates a schematic view of the method of processing waste material of the present invention using the system for processing waste material in accordance with the disclosed architecture.

FIG. 10 illustrates a chart illustrating results of using the system for processing waste material for the wastewater treatment of fish processing enterprises of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a system and method for using micro arc processing in a rotating magnetic field for high purification of urban domestic and industrial wastewater and sewage sludge with minimum energy consumption. It can also be the basis for the construction of sewage treatment systems of inhabited locality used local and centralized sewerage (sanatoriums, hospitals, schools, hotels, offices and shopping complexes), as well as treatment facilities of any type industrial enterprises, including food and light industry, processing of agricultural products, industrial livestock farms, poultry farms, etc.

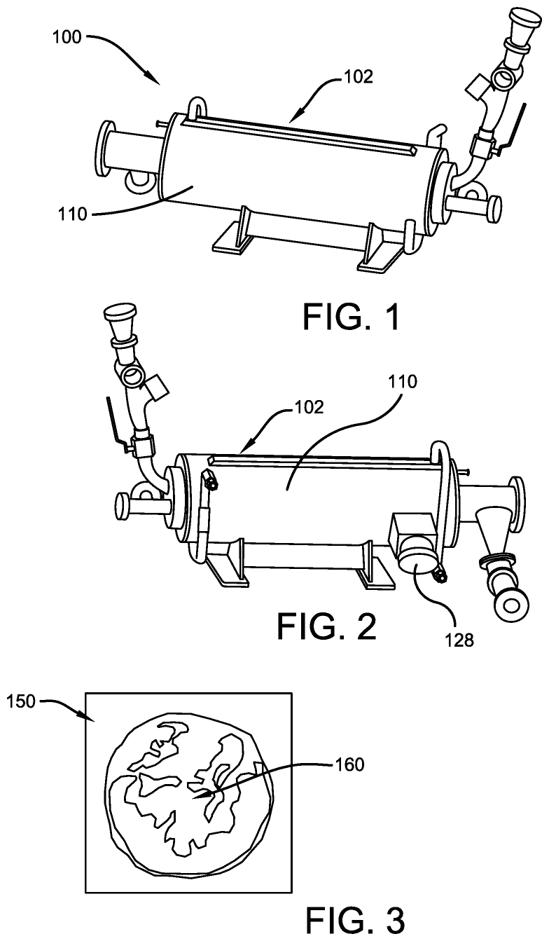

Referring initially to the drawings, FIGS. 1-6 illustrate a system 100 for processing waste material. The system 100 generates micro arcs and power micro impulses to treat the waste material. The system 100 comprises a tubular reactor 102 and a plurality of ferromagnetic elements 160. The system provides for the passage of material, such as gases, solids, or liquids, through the tubular reactor 102 in which an inductor generates a rotating electromagnetic field. The tubular reactor 102 comprises a housing 110 and a pair of flanges 112 positioned at opposing ends of the tubular reactor 110. The tubular reactor 102 is generally 30 to 50 cm in diameter and 400 to 1200 cm in length, although it can be smaller or larger in dimension as needed.

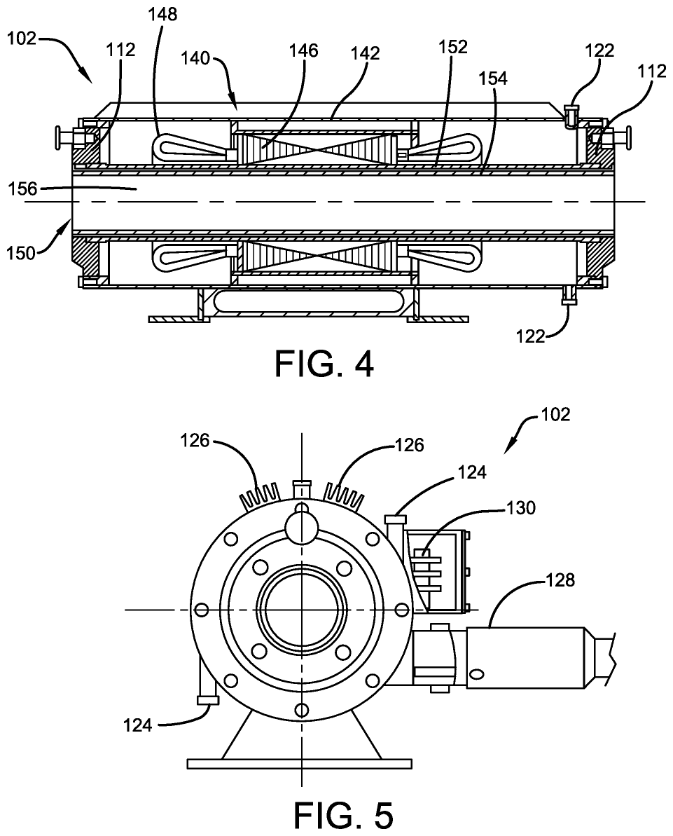

As illustrated in FIGS. 4 and 5, the tubular reactor 102 comprises a tubular chamber 150 and an inductor 140. The tubular chamber 150 comprises a shell 154 and a cylindrical working area 156. The cylindrical working area 156 is encapsulated by the shell 154. The shell 154 is magnetically nonreactive with the rotating electromagnetic field produced by the inductor 140. The shell 154 may be constructed from stainless non-magnetic steel AISI 321 or a basalt fiber. The tubular chamber 150 may further comprise a jacket 152. The jacket 152 may be an insulated sleeve or cooling jacket that lines the shell 154. The cooling jacket 152 is constructed to allow for the processing of waste substances at high temperatures up to at least 600 degrees Celsius.

The tubular reactor 102 further comprises control and thermal protection units, a frequency regulator of the supplied current from approximately 50 to 100 Hz, a power regulator installed in front of the inductor 140 in the range from approximately 5 to 100 kW with a continuous mode of its change, and a contactless phase switch with a switching frequency of approximately 50 to 100 periods per second. The tubular reactor 102 further comprises a power source 128 and a power regulator 130. The power regulator 130 is in electrical communication with the inductor 140. The tubular reactor 102 further comprises a reactor cooling component. The reactor cooling component is configured to cool the inductor 140. The reactor cooling component comprises a plurality of inlet pipes 122, a plurality of outlet pipes 124, and a plurality of fins 126 for containing a water-based or oil-based coolant. The tubular reactor can operate at a range of approximately five to 100 Kilowatts or higher.

The inductor 140 comprises a body 142, a magnetic core cassette 144, a magnetic circuit 146 and a winding 148. A core of the transformer of the inductor 140 may be laminated from electrical steel. The winding 148 is configured to generate the rotating electromagnetic field within the tubular working chamber 150 uniformly distributed and perpendicular to its axis. The winding 148 may be a symmetrical reduced two-layer loop, wire with oil-resistant insulation and operating temperature up to approximately to 200 degrees Celsius. Alternatively, the winding 148 may be constructed of wire with waterproof insulation with an operating temperature of up to approximately 90 degrees Celsius.

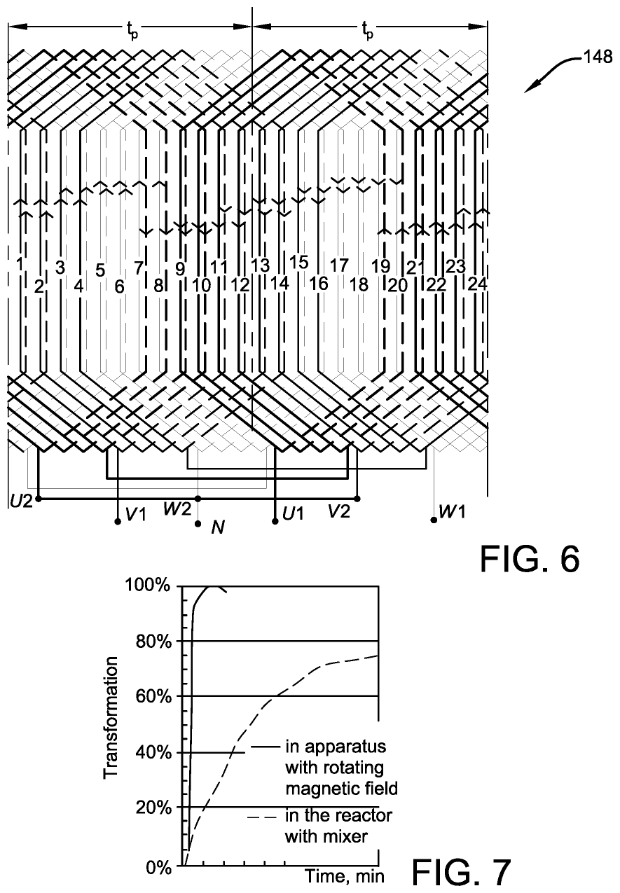

FIG. 6 illustrates a preferred winding scheme, where τp—indicates the pole pitch; V1, U1, W1—the beginning and V2, U2, W2—the ends of the phase windings, and N—neutral wire. The symmetrical two-layer loop reduced winding 148 ensures the symmetry of a three-phase inductor power supply system and improved magnetic field distribution in a stator core and the working chamber 156, equalizes magnetic field pulsations and electromagnetic system vibrations. A preferable range for the magnetic induction in the operating zone is from approximately 0.1 to 0.2 Tesla. The speed of rotation of the magnetic flux is preferably in the range from approximately 50 sec-1 to 100 sec-1, with the possibility of smooth adjustment. A core of the transformer of the inductor 140 may be constructed of extruded a composite ferromagnetic alloy.

The plurality of ferromagnetic elements 160 (hereinafter—“indenters”), are positional within the cylindrical working zone 156 of the non-magnetic tubular working chamber 150 that does not interact with the field. The plurality of ferromagnetic elements 160 are generally needle-shaped and configured to kinetically interact with the waste material when triggered by the rotating magnetic field generated by the inductor 140 as illustrated in FIG. 3. The activated plurality of ferromagnetic elements 160 generate the micro arcs and power micro impulses that kinetically treat the waste material.

As illustrated in FIG. 7, the processing results using a rotating magnetic field of the present invention and significantly better than those using a traditional mixer. Depending on the waste material to be treated, the plurality of ferromagnetic elements 160 may be coated with a can be coated with catalytic metals for certain processes (synthesis/distillation), or an elastic polymer shell to reduce contamination when processing substances with high purity requirements. The size of the ferromagnetic elements is most preferably in the range from 10 mm to 30 mm in length, and from 0.7 mm to 3 mm in diameter.

During their movement, the indenters continuously create micro arcs and power micro impulses, which in direct contact virtually no materials cannot withstand. The simultaneous influence of all these factors allows translating all processes in the working area 156 of the tubular reactor 102 into a kinetic mode, which in contrast to diffusion, inherent in all traditional processes, and, accordingly, dramatically increase the productivity of materials and media, increase the reaction rate, etc.

Under conditions of a strong electromagnetic field, powerful currents arise in the working bodies, leading to the formation of micro arcs when the micro circuits break during the rotational movement of the needles 160. Under the influence of the rotating magnetic field, the ferromagnetic elements 160 rotate with an accompanying change in polarity. With this magnetization reversal, there is a very rapid change in the discharge positions, entailing a rapid change in the linear size of the needles 160. As a result of these almost continuously emitted power impulses, a large force is applied to the environment (approximately 15 to 20 tons/mm2), acting over a small distance. In water, the extent or range of interaction of these pulses is several times larger than in solid-phase operations. When performing, the ferromagnetic elements 160 that fill the working chamber 156 gradually wear out, and the efficiency of the treatment process of necessary substances is reduced. Therefore, new indenters 160 are periodically supplied to the working chamber 156 by the dosing system 100, filling it with integral elements instead of the used ones. The indicator of filling of the working chamber 156 is the change of current of the phase winding 148 of the inductor 140, which is fixed by the devices and used by an automatic control system or operator.

When moving, the ferromagnetic working elements 160 continuously emit powerful local micro-impulses and micro-arcs (hereinafter “MIPMAP”). This action facilitates the intensive dispersion of any solid materials, as well as the mixing of the treated medium. Several effects are generated that combine with the local thermal and mechanical phenomena that occur when the ferromagnetic working elements 160 interact with a substance. The power of these effects is so great that, acting simultaneously on any particles of a substance, they provide structural and energy changes at the molecular and atomic level.

As a result of these interactions the wastewater to be treated is exposed to the following effects: particle dispersion; water ionization with separation of H+ and Hydroxyl Group OH−; weakening of intermolecular and interatomic bonds; oxidation/Reduction reactions (redox) by free radicals; magnetic field sustaining processes with highly ionized entities; magneto Hydrodynamic shocks comparable to cavitation processes or hydro-acoustic effects; intensive mixing; and localized thermal effects. The combined effect of all factors creates a very high level of activation of all components of the substance involved in the process. The reactions are no longer diffusion controlled but become a function of the discharge phenomena with associated increases in the rates of change or reaction kinetics. This process enables a rate increase in the treatment process by many orders of magnitude thereby reducing energy use and achieving processes previously considered unattainable.

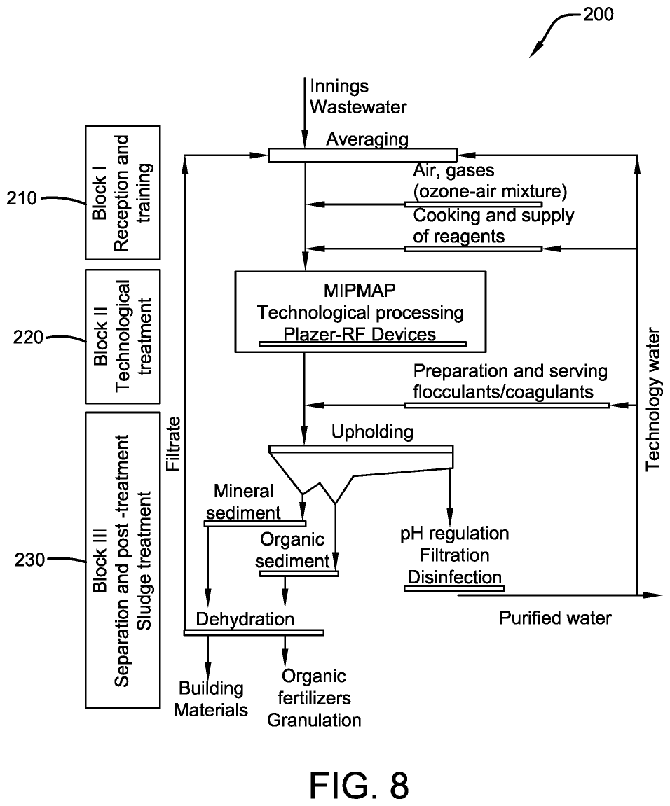

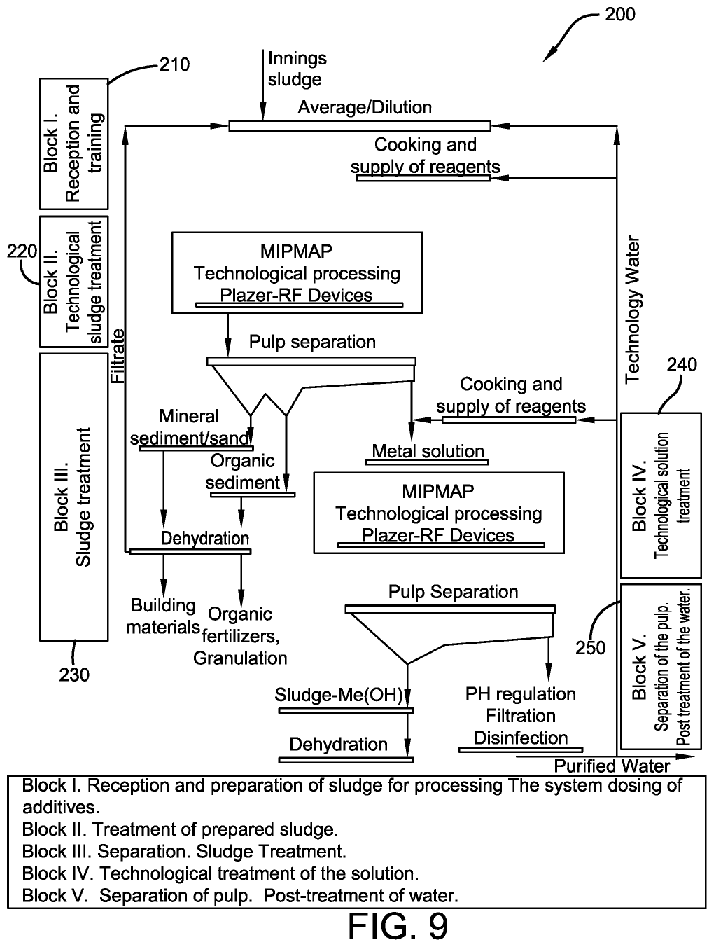

The subject matter disclosed and claimed herein, in another embodiment thereof as illustrated in FIGS. 8 and 9, comprises a method 200 for processing waste material using the system 100 for processing waste material. The system 100 generates micro arcs and power micro impulses to treat the waste material. The method 200 begins by pretreating the waste material using a traditional waste material treatment process at 210 which consists in the separation of magnetic components, separation of fat fractions, separation of solid particles and fragments for their further processing with a size of not more than 0.3-2.0 mm or their grinding to a size less than 0.3-2.0 mm. Then the pretreated waste material is treated with the system 100 for processing waste material comprising the tubular reactor 102 and the plurality of ferromagnetic elements 160 at 220 using a rotating electromagnetic field using microarcs and power micro pulses at values of magnetic field induction in the working area of the tubular reactor, which contains ferromagnetic needle elements, not less than 0.1-0.25 T.

As discussed supra, the tubular reactor 102 comprises the tubular chamber 150 and the inductor 140. The tubular chamber 150 comprises the nonreactive shell 154 and the cylindrical working zone 156 encapsulated by the shell 154. The inductor 140 comprises the winding 148. The winding 148 is configured to generate the rotating electromagnetic field around the tubular working chamber 150. The plurality of ferromagnetic elements 160 are positional within the cylindrical working area 156 of the tubular working chamber 150. The plurality of ferromagnetic elements 160 are needle-shaped and configured to kinetically interact with the waste material when activated by the rotating magnetic field generated by the inductor 140. The ferromagnetic needle elements 160 may have a diameter of 0.5-1 mm and a length of 8-12 to intensify the mixing of liquid media, or liquid with gaseous media (including the formation of micro- (nanosized) bubbles), and also to increase the degree of solubility of miscible media (including gaseous media in liquids). Alternatively, the ferromagnetic needle elements 160 may have a diameter of 1-1.6 mm and a length of 12-20 mm to intensify the mixing of liquid media with solid particles with simultaneous dispersion (grinding) of these solid particles (including to obtain suspensions), as well as to intensify the mixing of liquid media, which are not prone to mixing and dissolving with each other, and to obtain emulsions. Alternatively, the ferromagnetic needle elements 160 may have a diameter of 1.6-3.2 mm and a length of 20-40 mm for intensification of dispersion (grinding) and mixing of solid materials, as well as for mixing (grinding) of liquid and semi-liquid materials (media) with increased values kinematic of viscosity greater than 0.155 in²/s (100 mm²/s). The ratio m/V of the mass of the ferromagnetic needle elements (m in grams) to the volume of the working area of the tubular reactor (V in cm³) may be selected from the range: m/V=0.1-0.4 g/cm³.

The activated plurality of ferromagnetic elements 160 generate the micro arcs and power micro impulses that kinetically treats the waste material. Depending on the waste material to be treated, the plurality of ferromagnetic elements 160 may be coated with a catalytic metal or an elastic polymer shell.

The method 200 continues at 230 by separating the treated waste material into usable component materials which comprises subsequent separation of the obtained fractions (products) after treatment of waste in a rotating electromagnetic field using microarcs and power micro pulses. The method 200 may further comprises retreating at least a portion of the treated waste material with the system 100 for treating waste material at 240. Once retreated, the retreated waste material is separated into usable component materials at 250.

The processes in the reactor can be enhanced by the addition of chemical additives comprising sources of hydrogen and hydroxide ions that can become reactive entities in the reaction zone such as the formation of superoxide and super hydrogen ions and other energized species. These reagents are not limited to hydrogen and hydroxide entities but can include other chemicals gases, liquids and solids that decompose or react to form energized entities in the reaction zone of the MIPMAP reactor.

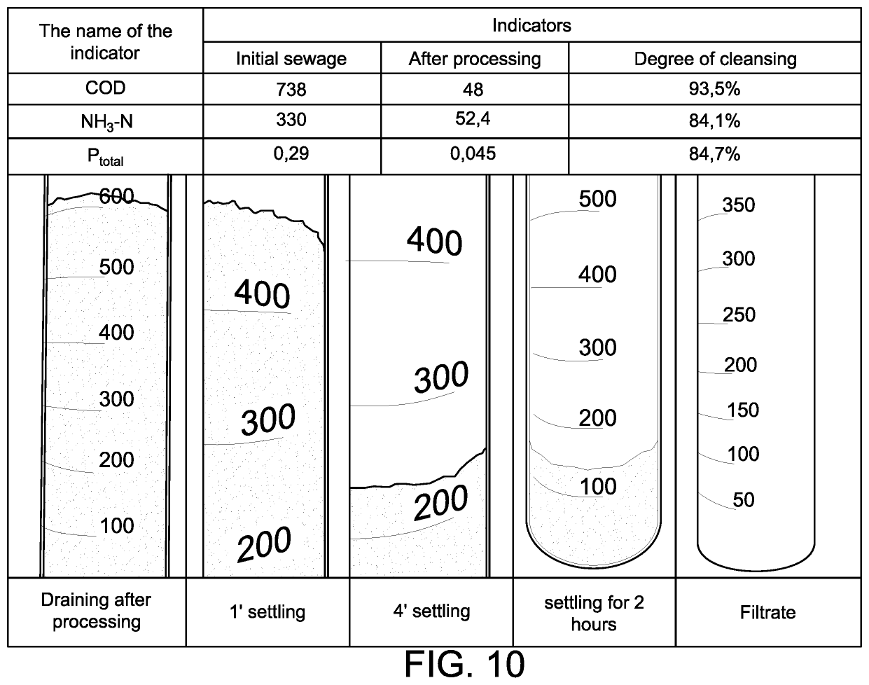

This unique combination of processes leads to accelerated chemical and physical interactions with rapid kinetics for the treatment processes. These are of both macro-duration and micro-duration. The outcomes from these complex reactions are that complex solids are formed with oxidation of heavy metals and removal of organic materials either through polymerization, breakdown, or adsorption. As illustrated in an example of a study on the wastewater treatment of fish processing enterprises shown in FIG. 10, the resultant water is free of living microbial organisms, trace organics, and heavy metals and suitable for most forms of re-use. The separated solid waste stream can be further treated for beneficial reuse or resource recovery, especially for nutrients. The solids removed are only that in the original wastewater with no added chemicals or biological by-products or sludges. The equipment of the present system provides a continuous flow through treatment of up to 10 m³/hr for each unit. Pretreatment requires grinding or settling to remove gross solids (solids to less than 2 mm and preferably around 500 microns) and post treatment with settling/filtration to remove solids.

The effect and advantages of micro arc processing in rotating magnetic fields using the system 100 and method 200 of the present invention is illustrated in several examples. The effect of micro arc processing in rotating magnetic fields on the content of poultry plants of microorganism organisms and cultures (as shown by the indicator organisms Escherichia coli and Staphylococcus aureus) in industrial wastes (litter) is provided in Table 1.

TABLE 1

| No. | Material | E-coli | St-aureus |
|---|---|---|---|
| 1 | Initial droppings of poultry | 10⁶ | 10⁶ |
| | farms (without processing) | | |
| 2 | The product after micro impulse | 0 | 0 |
| | microarc processing of droppings | | |
| | in rotating magnetic fields | | |

Determination of epidemic safety indicators of surface water for cattle manure is illustrated in Table 2.

TABLE 2

| | | Number of | Escherichia | |
|---|---|---|---|---|
| | | enterococci, | coli index, | Coli- |
| No. | Material | CFU in L | CFU in L | index |
| 1 | Initial cattle manure | 69 × 10³ | 15 × 10⁶ | 930 × 10⁶ |
| | (without processing) | | | |
| 2 | The product after | Is not | Is not | Is not |
| | micro impulse | detected | detected | detected |
| | microarc processing | | | |
| | (MIPMAP) | | | |

Effective wastewater treatment for galvanic production (Cr and Ni coating lines) using MIPMAP is illustrated in Table 3.

TABLE 3

| | Indicators, mg/l | | |
|---|---|---|---|
| Indicators | | | Degree of |
| name | Initial sewage | After processing | cleaning |
| COD | 264 | <0.2 | 99.9% |
| Cr total | 1.9 | 0.248 | 87.0% |
| Fe total | 440 | 0.07 | 99.9% |
| Ni | 16.3 | 0.5 | 97.0% |
| Zn | 1140 | 1.5 | 99.86% |
| Suspended particles | 108 | <4 | 96.3% |
| Oil Products | 13.0 | 0.17 | 98.7% |

Example of sludge sites processing from septic tanks of city aeration plant using devices for microarc processing in rotating magnetic fields. The composition of the initial sludge after the municipal wastewater treatment plants and after processing using MIPMAP technology is illustrated in Tables 4-5.

TABLE 4

| Water | | Organic | | N, | | | | | | | | | | | |
|---|---|---|---|---|---|---|---|---|---|---|---|---|---|---|---|
| content | | matters | Sand | total | P, | K, | Metals, mg/kg | | | | | | | | |
| % | pH | % | % | % | % | % | Sb | Hq | Pb | Cd | Ni | Cr | Mn | Zn | Cu |
| 82.6 | 7.4 | 35.6 | 30 | 2 | 3.7 | 0.03 | 38.5 | 5.0 | 224 | 118 | 164 | 3,635 | 462 | 5,840 | 1,306 |

TABLE 5

| | | Elements, mg/kg | | | | | | | | |
|---|---|---|---|---|---|---|---|---|---|---|
| Products | Units | Sb | Hg | Pb | Cd | Ni | Cr | Mn | Zn | Cu |
| Sewage sludge | mg/kg | 38.5 | 5 | 224 | 118 | 164 | 3,635 | 462 | 5,840 | 1,306 |
| (initial sludge) | | | | | | | | | | |

Derived products from sewage sludge

| | | | | | | | | | | |
|---|---|---|---|---|---|---|---|---|---|---|
| Organic sediment | mg/kg | — | — | 0.06 | 0.004 | 0.03 | 0.1 | 0.2 | 0.08 | 0.6 |
| (organic | | | | | | | | | | |
| fertilizer) | | | | | | | | | | |
| Metallic | mg/kg | 120 | — | 2,900 | 330 | 4,400 | 5,100 | 7,600 | 3,400 | 3,100 |
| concentrate | | | | | | | | | | |
| (metal hydroxide | | | | | | | | | | |
| sediment) | | | | | | | | | | |
| Recycling water | mg/l | — | — | 0.05 | — | 0.25 | 0.01 | — | — | 0.40 |

The metal content in the solution at various durations of cementation by iron is illustrated in Table 6.

TABLE 6

| | Metal content in solution, mg/L | | | |
|---|---|---|---|---|
| Metals | original solution | after 5 sec | after 10 sec | after 60 sec |
| Pt | 10 | 3.700 | 0.013 | 0.0 |
| Pd | 10 | 0.043 | 0.000 | 0.0 |
| Ir | 10 | 0.350 | 0.024 | 0.0 |
| Rh | 10 | 1.820 | 1.820 | 1.5 |

Exemplary areas of application of micro pulse micro arc processing in rotating magnetic fields (MIPMAP) are illustrated in Table 7 (NQ—indicates a positive increase but not quantified—process dependent)

TABLE 7

| | | Increase in specific indicators of | | | |
|---|---|---|---|---|---|
| | | traditional technologies (q-ty times) | | | |
| | Traditional | | Reduction | Reduced | |
| | technologies or | Productivity | of metal | power | Additional |
| Technology | equipment | growth | consumption | consumption | indicators |
| Mining | Methods of | NQ | NQ | NQ | Replace bulky |
| chemistry | hydrometallurgy | | | | vats and columns |
| | | | | | with compact |
| | | | | | plants and |
| | | | | | hydrocyclones |
| Extraction of | Acid dissolution, | 800-1,000 | NQ | NQ | A mobile line is |
| valuable | solvent extraction | | | | provided to the |
| components | electrochemistry | | | | development site |
| from ores with | | | | | |
| a low content of | | | | | |
| elements such | | | | | |
| as tungsten, | | | | | |
| gold, etc. | | | | | |
| Processing of | Traditional | NQ | NQ | NQ | The yield is 5 to |
| dumps for the | processing | | | | 10 times higher. |
| purpose of | systems | | | | Capital costs are |
| extracting | (hydrometallurgy) | | | | 20-100 times |
| valuable | | | | | lower. |
| impurities | | | | | |
| (gold, copper, | | | | | |
| nickel, etc.) | | | | | |
| Powder | Vibro- and ball | 100-200 | 15-20 | 100-120 | The grinding |
| metallurgy: | mills Mixers | 80-100 | 15-20 | 100-120 | speeds increase |
| a) grinding, | For iron | 2-3 | Comparable | 5-6 | sharply; the |
| obtaining | 1500 degrees C. | 100-120 | Comparable | 100-120 | powder is |
| nanopowders | in atmosphere H₂ | | | | activated. |
| [symbol] ) mixing | | | | | Very high |
| B) sintering | | | | | quality mixing |
| Γ) production | | | | | The sintering |
| of metal | | | | | temperature is |
| plastics | | | | | reduced by 100- |
| | | | | | 200° C. |
| | | | | | Sintering without |
| | | | | | protection at a |
| | | | | | temperature of |
| | | | | | 100-140° C. |
| Manufacture of | There are no | — | — | — | Sand is |
| waterproof | analogues | | | | processed with |
| sand for | | | | | additives at |
| waterproofing | | | | | normal |
| (hydrophobic | | | | | temperature and |
| materials) | | | | | pressure |
| Chemical | At high | NQ | NQ | NQ | The processes |
| industry | temperatures | | | | take place at low |
| a) | and pressures | | | | temperatures and |
| Homogeneous | using special | | | | pressures, which |
| processes | equipment | | | | makes it possible |
| b) | | | | | to simplify the |
| heterogeneous | | | | | equipment. The |
| processes | | | | | reaction rates are |
| | | | | | increased, this |
| | | | | | leads to a |
| | | | | | reduction in the |
| | | | | | range and size of |
| | | | | | the equipment. |
| Electronic | Vibro- and ball | NQ | NQ | NQ | Enhancing the |
| industry, | mills Mixers | | | | characteristics of |
| Activation, | | | | | electronic |
| grinding of | | | | | components and |
| ceramic | | | | | materials |
| materials for | | | | | |
| electronic | | | | | |
| components, | | | | | |
| boards, etc. | | | | | |
| Neutralization | Volumetric | 250 | 10 000 | Up to 10 | Reduction of |
| and utilization | accumulators of | | | | the content of |
| of bilge water | oil-containing | | | | petroleum |
| on ships and in | water | | | | products up to |
| ports. | | | | | MPC |
| Manufacture | Ball and roller | NQ | NQ | NQ | The quality of |
| of oil and | mills | | | | oil paints |
| facade paints | | | | | corresponds to |
| | | | | | the |
| | | | | | specification, |
| | | | | | facade-above. |
| Production of | Feed-processing | 5-10 | 5 000- | Comparable | Granules with low |
| mixed fodders | plants | | 10 000 | | production costs |
| from local raw | | | | | were obtained |
| materials | | | | | |
| Extraction of | Extraction takes | NQ | NQ | NQ | The extraction |
| essential oils, etc. | place at long | | | | takes place at |
| from field plants | exposures in alcohol | | | | room temperature |
| | and oils | | | | and the oils are not |
| | | | | | damaged |

Among the benefits and advantages of the innovative technology of the present invention is the possibility of complete sewage utilization to get commercial products, including purified water, organic fertilizers, purified fine sand, and metal concentrates. Biological treatment systems do not achieve complete cycle of sewage disposal, as there is a need of additional disposal of sludge, including its disinfection and dehydration. At the same time, there is a problem of cleaning heavy metals from the sludge which cannot be solved on site in most cases. A very important advantage of the innovative technology is the dispensing of the necessity for sludge beds. These can occupy tens and hundreds of acres in large biological treatment plants and can cause extensive damage to ecology. In addition, the equipment for microarc processing in rotating magnetic fields differs from conventional technology by using significantly lower materials intensity and lower power intensity for the purification process.

Notwithstanding the forgoing, the system 100 can be any suitable size, shape, and configuration as is known in the art without affecting the overall concept of the invention, provided that it accomplishes the above stated objectives. One of ordinary skill in the art will appreciate that the shape and size of the system 100 and its various components, as show in the FIGS. are for illustrative purposes only, and that many other shapes and sizes of the system 100 are well within the scope of the present disclosure. Although dimensions of the system 100 and its components (i.e., length, width, and height) are important design parameters for good performance, the system 100 and its various components may be any shape or size that ensures optimal performance during use and/or that suits user need and/or preference. As such, the system 100 may be comprised of sizing/shaping that is appropriate and specific in regard to whatever the system 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for processing waste material comprising:
a tubular reactor comprising:
a tubular chamber comprising a cylindrical working area encapsulated inside a shell; and
an inductor comprising a winding configured to generate a rotating electromagnetic field within the tubular chamber uniformly distributed within and perpendicular to its axis; and
a plurality of ferromagnetic elements positional within the cylindrical working area.

2. The system for processing waste material of claim 1, wherein the tubular reactor operates at a frequency of 50 to 100 Hertz.

3. The system for processing waste material of claim 1, wherein the tubular reactor further comprises a power regulator in electrical communication with the inductor.

4. The system for processing waste material of claim 1, wherein the winding operates at up to 180 degrees Celsius.

5. The system for processing waste material of claim 1, wherein the tubular reactor operates at a switching frequency of 50 to 100 periods per second.

6. The system for processing waste material of claim 1, wherein the shell of the tubular chamber is nonreactive with the rotating electromagnetic field.

7. The system for processing waste material of claim 1, wherein the shell of the tubular chamber is a basalt fiber shell.

8. The system for processing waste material of claim 1, wherein the tubular chamber further comprises a jacket encapsulating the shell.

9. The system for processing waste material of claim 8, wherein the jacket is a cooling jacket.

10. The system for processing waste material of claim 1, wherein the winding is a symmetrical reduced two-layer loop.

11. The system for processing waste material of claim 1, wherein the plurality of ferromagnetic elements are needle-shaped.

12. The system for processing waste material of claim 1, wherein the plurality of ferromagnetic elements are coated with a catalytic metal.

13. The system for processing waste material of claim 1, wherein the plurality of ferromagnetic elements are coated with an elastic polymer shell.

14. A system for processing waste material comprising:
a tubular reactor comprising:
a tubular chamber comprising a cylindrical working area encapsulated within a nonreactive shell; and
an inductor comprising a winding configured to generate a rotating electromagnetic field within the tubular chamber uniformly distributed within and perpendicular to its axis;
a reactor cooling component for cooling the inductor; and
a plurality of needle-shaped ferromagnetic elements positional within the working cylindrical area configured to interact with the rotating electromagnetic field.

15. The tubular reactor of claim 14, wherein each of the plurality of needle-shaped ferromagnetic elements are less than 3 millimeters in diameter and less than 30 millimeters in length.

16. The tubular reactor of claim 14, wherein the winding has an operating temperature of up to 90 degrees Celsius.

17. A method for processing waste material using a system for processing waste material configured to generate a rotating electromagnetic field, the method comprising:
pretreating the waste material by separating out and reducing in size to 2.0 mm or less any magnetic components, fat fractions, solid particles, and fragments;
treating the pretreated waste material with the system for processing waste material using a rotating electromagnetic field using microarcs and power micro pulses at values of magnetic field induction in a working area of a tubular reactor; and
separating the treated waste material into usable products.

18. The method of claim 17 further comprising the step of retreating at least of portion of the treated waste material with the system for processing waste material.

19. The method of claim 18 further comprising the step of separating the retreated waste material.

20. The method of claim 17, wherein the system for processing waste material comprises:
a tubular reactor comprising:
a tubular chamber comprising a cylindrical working area encapsulated within a nonreactive shell; and
an inductor comprising a winding configured to generate a rotating electromagnetic field within the tubular chamber uniformly distributed within and perpendicular to its axis;
a reactor cooling component for cooling the inductor; and
a plurality of needle-shaped ferromagnetic elements positional within the working cylindrical area configured to interact with the rotating electromagnetic field.
